(19) United States
(12) Patent Application Publication
(10) Pub. No.: US 2024/0419181 A1
(43) Pub. Date: Dec. 19, 2024

(54) AUTONOMOUS MOBILE SERVICE ROBOT SYSTEM FOR RECOGNIZING AUTOMATIC DOOR

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 18/260,023

(22) PCT Filed: Jun. 26, 2023
(86) PCT No.: PCT/KR2023/008855

§ 371 Date: Jun. 29, 2023

(30) Foreign Application Priority Data
Aug. 31, 2022 (KR) 10-2022-0109878

(51) Int. Cl. G05D 1/246; G05D 1/622; G05D 101/10; G05D 107/60; G05D 111/10; G05D 111/67

(52) U.S. Cl. CPC G05D 1/246; G05D 1/622; G05D 2101/10; G05D 2107/60; G05D 2111/17; G05D 2111/67

(57) ABSTRACT

Disclosed is an autonomous mobile service robot system for recognizing an automatic door and, in more detail, an autonomous mobile service robot system for recognizing an automatic door, the autonomous mobile service robot system enabling an autonomous mobile service robot to recognize an automatic door during moving, pass through the automatic door without an error in determination, and autonomously drive safely and stably for services by recognizing and defining information about an automatic door in simultaneously localization map-building (SLAM) of an autonomous mobile service robot that is operated for multiple purposes so that an accurate map considering location information of the automatic door is built.

### TECHNICAL FIELD

The present disclosure relates to an autonomous mobile service robot system for recognizing an automatic door and, in more detail, an autonomous mobile service robot system for recognizing an automatic door, the autonomous mobile service robot system enabling an autonomous mobile service robot to recognize an automatic door during moving, pass through the automatic door without an error in determination, and autonomously drive safely and stably for services by recognizing and defining information about an automatic door in simultaneously localization map-building (SLAM) of an autonomous mobile service robot that is operated for multiple purposes so that an accurate map considering location information of the automatic door is built.

### BACKGROUND ART

In the service industry that provides services such as restaurants, recently, the problem of service response is emerged, and the introduction of a 52-hour workweek and the increase in the minimum wage are in progress, increasing the burden of labor costs. Accordingly, the unmanned service market that does not employ employees has been rapidly expanded.

In particular, a KIOSK, which is an unmanned information guide system for providing unmanned orders and payments, is actively used by the service companies.

However, in a case of the service that provides foods or drinks completed through a cooking or a processing, the development of the unmanned technology is insufficient.

Due to the insufficiency of such technology development, currently, in Korea, the demand for the serving robots is being met by importing and then, selling or leasing the serving robots.

However, since these imported serving robots are rather expensive, one serving robot is a burden on restaurant companies in terms of economic efficiency and productivity.

Therefore, at a time when companies are considering new types of restaurants such as futuristic and unmanned restaurants, there is an urgent need for domestically developed products that are inexpensive and have excellent functions.

In addition, current service robots need markers for indoor location recognition on the ceiling for indoor driving thereof.

That is, in order to utilize the service robots, since the markers for indoor location recognition are necessarily required, there is a problem that a remodeling work of the indoor ceiling must be accompanied.

In addition, since most of the conventional service robots do not recognize transparent objects, there is a risk of a deviation from the driving path and a safety accident due to driving errors and unnatural driving. In addition, even if the service robot can recognize the transparent object, since the robot should be configured with expensive equipment, it is not easily utilized.

In food service companies and restaurant business such as restaurants, coffee shops, fast-food restaurants, family restaurants, and special restaurants as well as the industries that require various services such as museums, department stores, and public institutions, even without expensive equipment, the present invention intends to provide a service serving robot with an excellent service robot usability that can satisfy the needs of customers on behalf of employees and guides as well as recognize an automatic door without markers and enable it to autonomously drive along a driving path in which information on the automatic door is considered.

In other words, it is intended to provide a service robot capable of recognizing the automatic door, passing through the automatic door, and driving in a predetermined indoor space without being unable to drive or making an error in judgment.

Accordingly, as a prior art for the autonomous mobile service robot system recognizing an automatic door, “a moving robot and a control method thereof” of Korean Patent Laid-Open Publication No. 10-2019-0106910 (hereinafter referred to as “Patent Literature 1”) is disclosed.

Patent Literature 1 relates to a moving robot and a control method thereof of providing the control method for the moving robot includes: a step of receiving user input including a predetermined service request by a moving robot; a step of receiving an article to be served, by the moving robot; a step of extracting a serving position by searching a user and analyzing a user's gesture by the moving robot; a step of extracting the distance and height of the serving position by analyzing an image of the serving position; a step of moving to the serving position and lifting the article to be served to the height of the serving position; and a step of horizontally moving the article to be served to the serving position and placing the article to be served at the serving position.

As another prior art, “a serving robot and a customer serving method using the same” of Korean Patent Laid-Open Publication No. 10-2019-0092337 (hereinafter referred to as “Patent Literature 2”) is disclosed.

In Patent Literature 2, the serving robot incudes a camera for obtaining image data including at least one of an expression and a gesture of a customer associated with food; a microphone for obtaining voice data including a voice of a customer associated with the food; and a processor for obtaining customer response data including at least one of the image data and the voice data through at least one among the camera and the microphone, estimating a response of the customer to the food from the obtained customer response data, and generating or updating customer management information corresponding to the customer on the basis of the estimated response. According to the embodiment, the serving robot can estimate a customer's response from the customer response data through an artificial intelligence-based learning model.

As described above, Patent Literatures 1 and 2 are technologies related to the serving robot that responds to the customer in the field, and has the same technical field as the present invention, however the technical characteristics of the invention are different from each other.

That is, Patent Literatures 1 is a technology for a serving robot that allows the user to directly withdraw the serving article accommodated by the serving robot from the user's desired location to provide it to the user, without withdrawing the serving article by means of the user.

Patent Literature 2 is a technology for a serving robot that can easily identify and manage the tastes of customers using the restaurant, by estimating the customer's response (food-related customer expression and gesture) from customer response data obtained by using a camera or a microphone and updating management information about the customers.

Accordingly, Patent Literature 1 and Patent Literature 2 are different from the present invention in terms of the problem to be solved by the invention, the means for solving the problem, and the effect exerted by solving the problem.

Accordingly, the present invention is different from the technology for the conventional service serving robots including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Laid-Open Publication No. 10-2019-0106910 (Sep. 18, 2019).

Patent Literature 2: Korean Patent Laid-Open Publication No. 10-2019-0092337 (Aug. 07, 2019)

### DISCLOSURE

### Technical Problem

Accordingly, the present disclosure has been made in an effort to solve the problems of the related art described above, and an objective of the present disclosure is to provide an autonomous mobile service robot system for recognizing an automatic door, the autonomous mobile service robot system recognizing and defining an automatic door in simultaneously localization map-building (SLAM) of an autonomous mobile service robot that is operated for multiple purposes at various specific indoor places so that an accurate map including information about the defined door is built.

Another objective of the present disclosure is to provide an autonomous mobile service robot system for recognizing an automatic door, the autonomous mobile service robot system enabling easy mass production and management of autonomous mobile service robots and maximizing the effect of superiority in price competition by enabling an autonomous mobile service robot to recognize and define an automatic door using 2D-Lidar that is one of Lidar sensors and RGB-D that is one of camera sensors without using expensive sensors when recognizing and defining an automatic door.

### Technical Solution

According to one aspect of the present invention so as to accomplish these objects, there is provided to an autonomous mobile service robot system for recognizing an automatic door, including:

an autonomous mobile service robot providing service by moving and driving in a predetermined indoor space in accordance with specific paths and specific signal; and

an automatic door definition loop constructor preventing errors in moving and driving of the autonomous mobile service robot to be able to pass through an automatic door in the predetermined indoor space by recognizing and defining the automatic door existing in the predetermined indoor space when building a map of the autonomous mobile service robot and by applying information about the defined automatic door to moving and driving of the autonomous mobile service robot,

wherein recognition and definition of the automatic door that are determined by the automatic door defining loop constructor are processed on the basis of sensing information obtained from a surrounding environment information sensing unit disposed in the autonomous mobile service robot, whereby the information about the automatic door is recognized and defined.

At this time, the automatic door defining loop constructor includes:

a repeat learning automatic door location automatic selection module that senses and selects a location candidate group of automatic doors when a map of a predetermined indoor space is initially built by the autonomous mobile service robot, and determines the locations of the automatic doors by comparing a map that is built by repeated driving in the predetermined indoor space with the initially built map such that the locations of the automatic doors are updated in a map; and

a manager automatic door location manual selection module that senses and selects a location candidate group of automatic doors when a map of a predetermined indoor space is initially built by the autonomous mobile service robot, and determines the locations (coordinates) of the automatic doors in the built map such that the locations of the automatic doors are updated in the map by a manager,

whereby the autonomous mobile service robot can recognize the locations of the automatic doors, pass through the automatic doors while driving, and then provide service.

In addition, the location candidate group of automatic doors is sensed and selected through the automatic door defining loop constructor such that locations at which the autonomous mobile service robot cannot move forward, and is interfered while moving, senses shock, or tries to avoid obstacles while driving and locations at which an error is generated in driving of the autonomous mobile service robot are sensed and selected as the location candidate group of automatic doors when a map of a predetermined indoor space is built by the autonomous mobile service robot.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above with the configuration and operations, according to the present invention described above, there are following effects.
1. An autonomous mobile service robot safely and stably drives in a specific indoor space by recognizing automatic doors on the basis of specific signals and path information.
2. It is possible to provide an autonomous mobile service robot that can completely recognize and define automatic doors by processing sensing information obtained by the autonomous mobile service robot even without using an expensive sensor.

That is, the autonomous mobile service robot can completely build a map of a specific space with automatic doors by completely recognizing and defining the automatic doors on the basis of information sensed by only 2D-Lidar that is one of Lidar sensors and RGB-D that is one of camera sensor, and then by reflecting the information regarding automatic doors when building the map.
3. Since the autonomous mobile service robot can recognize automatic doors, it is possible to create an optimal path of a specific indoor space to which the information about the automatic doors is applied.
4. The ability of recognizing and avoiding obstacles of the autonomous mobile service robot is maximized.
5. Further, when the autonomous mobile service robot passes through an automatic door of which the location information has been determined while driving, the autonomous mobile service robot can open the automatic door and smoothly drive by transmitting a signal to the automatic door in advance.

That is, the present disclosure can be considered as a very effective invention that enables a service robot to completely drive fully in consideration of presence of automatic doors without a driving determination error and unnatural motions due to presence of automatic doors when autonomously driving by recognizing and defining automatic doors, as described above.

### BRIEF DESCRIPTION OF DRAWINGS

The above and other objects, features and advantages of the present invention will be more apparent from the following detailed description taken in conjunction with the accompanying drawings, in which:

FIG. 1 is a conceptual diagram of an autonomous mobile service robot system for recognizing an automatic door of the present disclosure;

FIG. 2 is a configuration diagram of the autonomous mobile service robot system for recognizing an automatic door of the present disclosure;

FIG. 3 is a conceptual diagram of an autonomous mobile service robot of the components of the autonomous mobile service robot system for recognizing an automatic door of the present disclosure;

FIG. 4 shows a first embodiment of the autonomous mobile service robot of the components of the autonomous mobile service robot system for recognizing an automatic door of the present disclosure;

FIG. 5 shows a second embodiment of the autonomous mobile service robot of the components of the autonomous mobile service robot system for recognizing an automatic door of the present disclosure;

FIG. 6a is a schematically conceptual diagram of a H/W configuration and a S/W stack for a robot body system of the components of the autonomous mobile service robot system for recognizing an automatic door of the present disclosure;

FIG. 6b is a schematically conceptual diagram of a guidance, a navigation, and a control for a robot body system of the components of the autonomous mobile service robot system for recognizing an automatic door of the present disclosure;

FIG. 7 is an operation flowchart of the autonomous mobile service robot of the components of the autonomous mobile service robot system for recognizing an automatic door of the present disclosure;

FIG. 8 is a block diagram of a robot control unit of the components of the autonomous mobile service robot system for recognizing an automatic door of the present disclosure;

FIG. 9 shows an embodiment of combining a robot body system and a robot function attachment/detachment module of the components of the autonomous mobile service robot system for recognizing an automatic door of the present disclosure;

FIG. 10 shows another embodiment of the autonomous mobile service robot of the components of the autonomous mobile service robot system for recognizing an automatic door of the present disclosure;

FIG. 11 shows a block diagram and a flowchart of a transparent object defining loop constructor of the components of the autonomous mobile service robot system for recognizing an automatic door of the present disclosure;

FIG. 12 is an entire flowchart of the transparent object defining loop constructor of the components of the autonomous mobile service robot system for recognizing an automatic door of the present disclosure;

FIG. 13 is a flowchart of a transparent object recognition SLAM building information preparation module of the transparent object defining loop constructor of the components of the autonomous mobile service robot system for recognizing an automatic door of the present disclosure;

FIG. 14 is a flowchart of a transparent object recognition SLAM building settlement module of the transparent object defining loop constructor of the components of the autonomous mobile service robot system for recognizing an automatic door of the present disclosure;

FIG. 15 is a flowchart of a transparent object recognition SLAM building completion module of the transparent object defining loop constructor of the components of the autonomous mobile service robot system for recognizing an automatic door of the present disclosure;

FIG. 16 is a second conceptual diagram of the autonomous mobile service robot system for recognizing an automatic door of the present disclosure; and

FIG. 17 briefly shows a flowchart when passing through an automatic door by the autonomous mobile service robot system for recognizing an automatic door of the present disclosure.

### Reference Signs List

1: Autonomous mobile service robot
2: Autonomous mobile service robot system for recognizing automatic door
100: Robot body system
110: Power source unit
120: Additional function module mount unit
121: Module mount interface
130: Robot control unit
131: Serving mode activator
132: Module decoder
132a: Module mounting checking element
132b: Module loading element
132c: Additional function activation element
132d: Additional function mode synchronization determination element
133: Power source controller
134: Driving space constructor
134a: SLAM performing module
134b: Built-map correcting module
134c: Built-map 2D converting module
134d: Final driving space map building module
135: Path setting unit
135a: Driving path performing module
135b: Driving path validity verifying module
135c: local/global area return setting module
135d: Navigation difference calibrating module
136: Robot driving controller
136a: Actuator node control module
136b: Open board module
136c: Control platform porting module
136d: Cooperation checking module
140: Surrounding environment information sensing unit
200: Robot function attachment/detachment module
210: Module mounting/separating element
220: Inherent function revealing element
221: Crime prevention function module object
222: Advertisement function module object
223: Carrying function module object
224: Cleaning function module object
225: Disinfection sanitization function module object
226: Air purification function module object
230: Inherent function coding element
300: Transparent object defining loop constructor
310: Transparent object recognition SLAM building information preparation module
311: SLAM parameter loading element
312: SLAM parameter checking element
313: SLAM parameter information time synchronization checking element
314: Autonomous mobile service robot transform applying element
315: Autonomous mobile service robot driving environment information publishing element
316: Autonomous mobile service robot driving environment information subscribing element
320: Transparent object recognition SLAM building settlement module
321: Driving distance information calculation element
322: Loop combination noise removal SLAM optimization element
323: Cholesky factorization-using problem solving element
324: SLAM transparent object recognition settlement element
324a: 3D space SLAM transparent object recognition settlement filter
324b: Transparent opaque object point cloud distinguish settlement filter
325: Point cloud voxel filter applying element
326: SLAM optimization information applying element
327: Space SLAM size setting element
328: Indoor space SLAM creating element
329: SLAM ratio size information creating element
330: Transparent object recognition SLAM building completion module
331: SLAM building additional information checking element
332: Autonomous mobile service robot SLAM work finishing element
400: Automatic door defining loop constructor
410: Repeat learning automatic door location automatic selection module
420: Manager automatic door location manual selection module
430: Automatic location checking unit
500: Automatic opening signal creating/transmitting unit
510: Real-time automatic door opening/closing information reception module
520: Automatic door opening signal transmission module
S100: Independent module docking step
S200: Independent module docking checking step
S300: Independent module function mode loading step
S400: Serving robot complex function performing checking step
S500: Serving robot complex function activation step
H: Serving robot housing
P: Emotional speech outputting unit
SD1: First specific reference value
SD2: Second specific reference value

### BEST MODE

### Mode for Invention

Hereinafter, functions, configurations, and operations effects of an autonomous mobile service robot system for recognizing automatic door (2) according to the present invention will be described in detail with reference to the accompanying drawings.

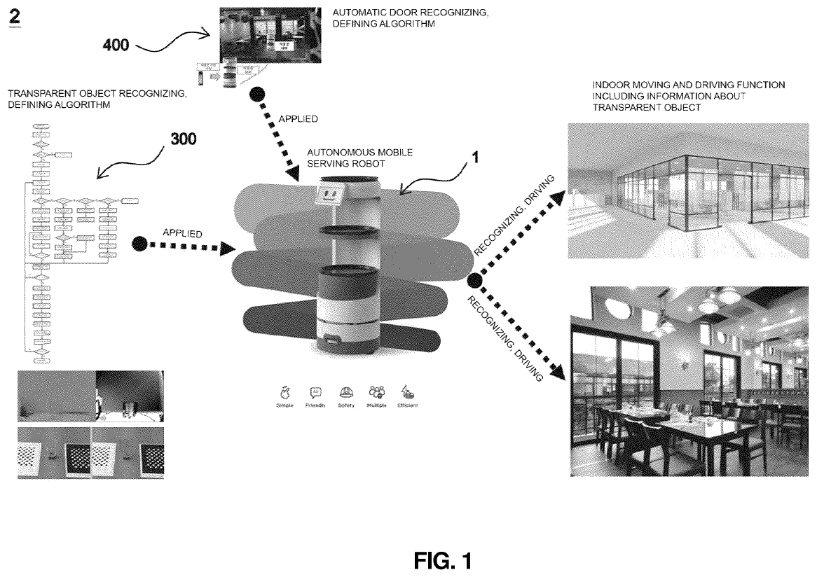

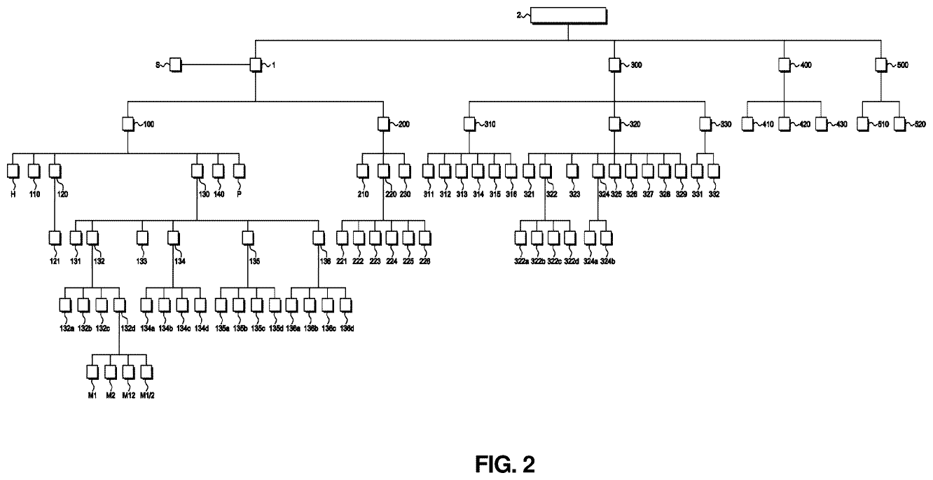

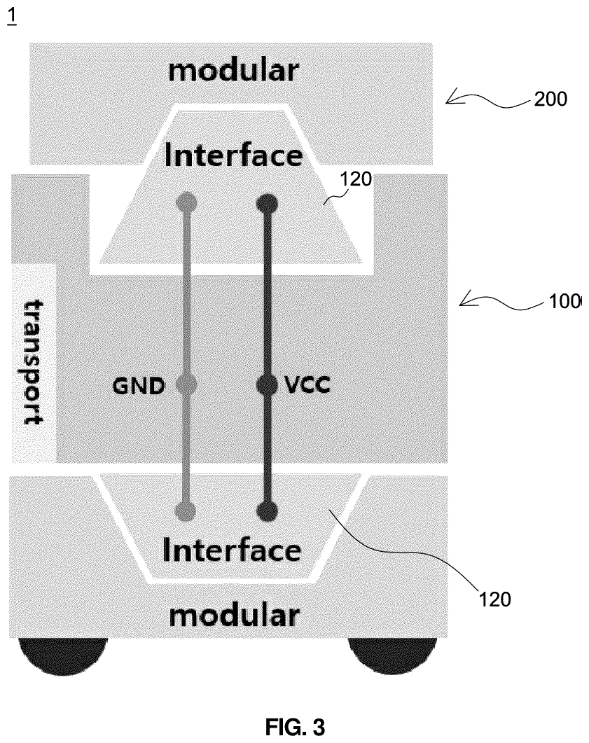

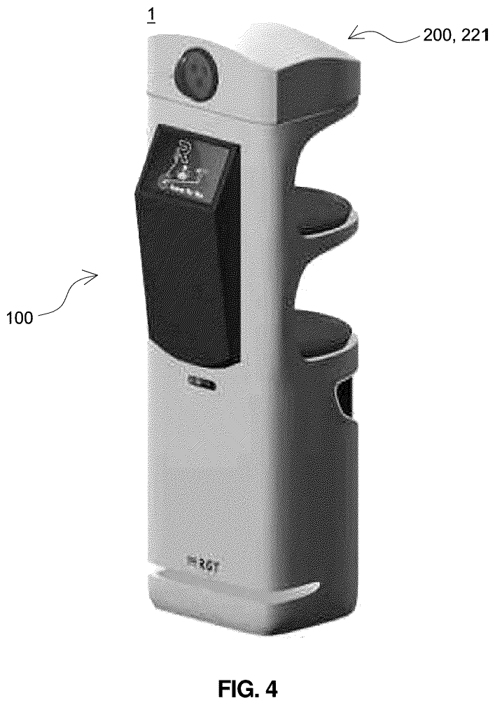

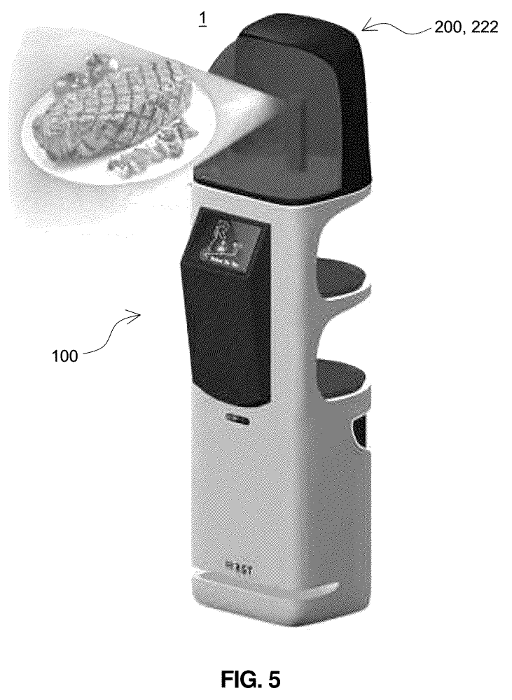

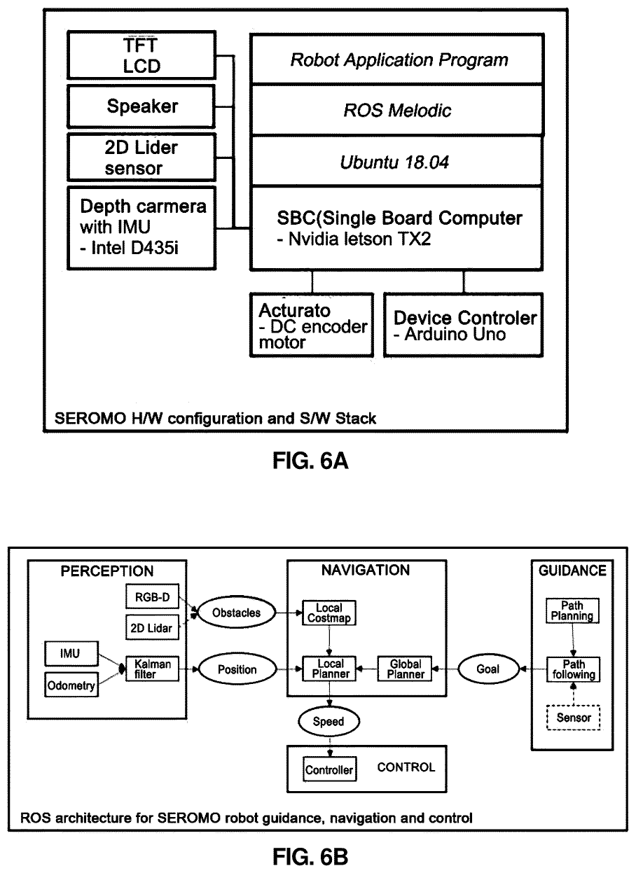

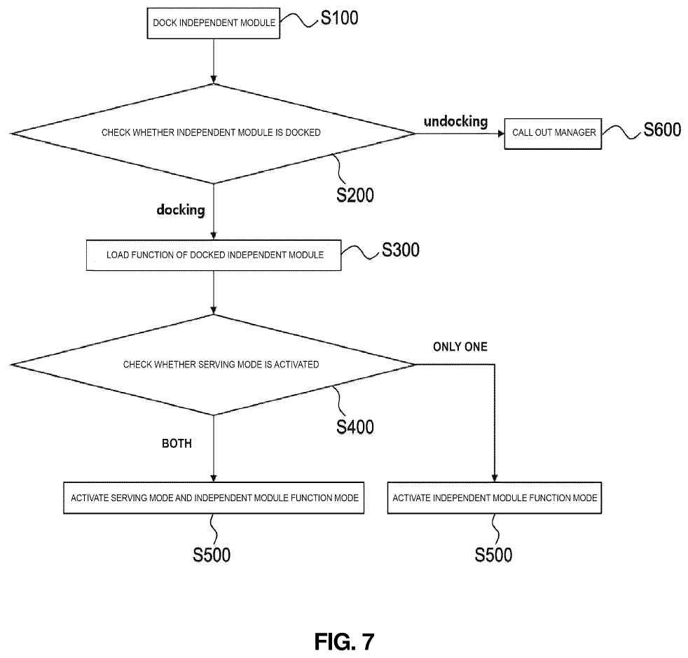

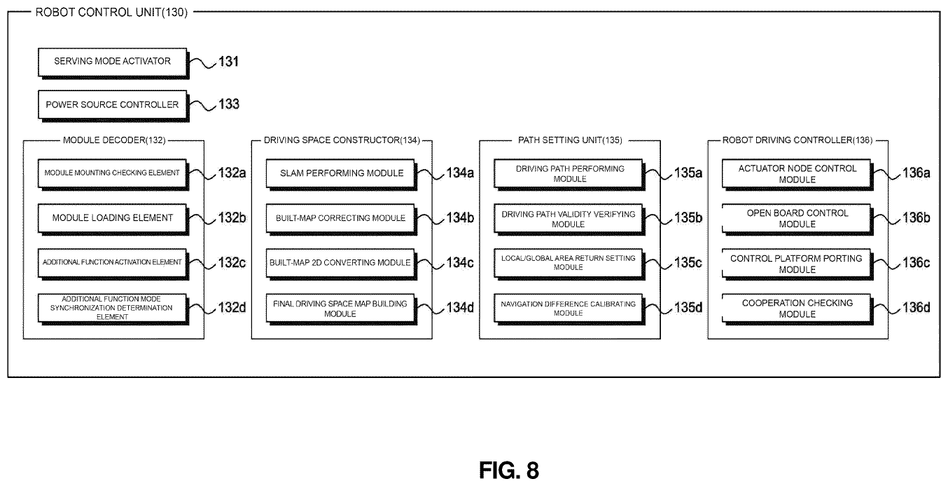

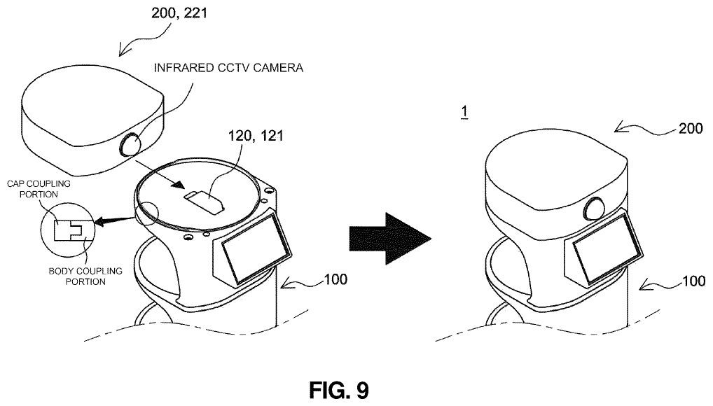

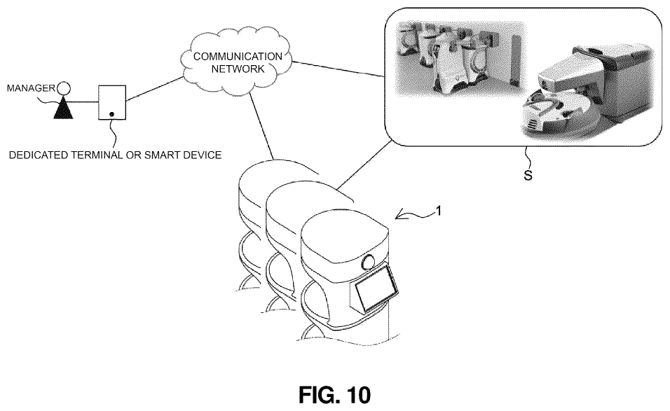

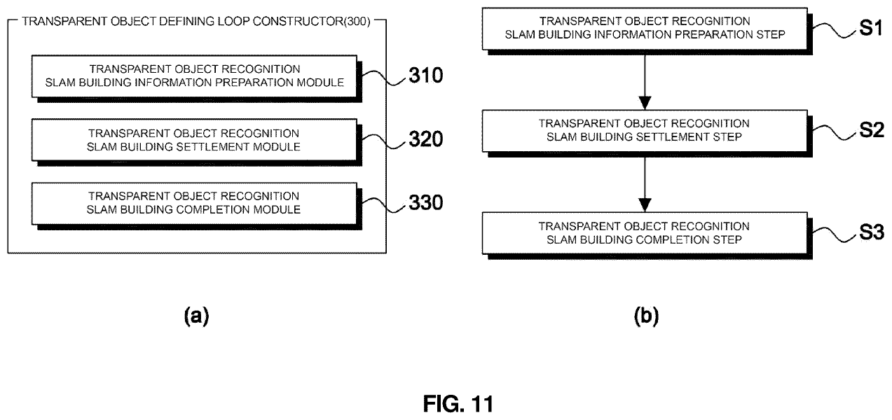

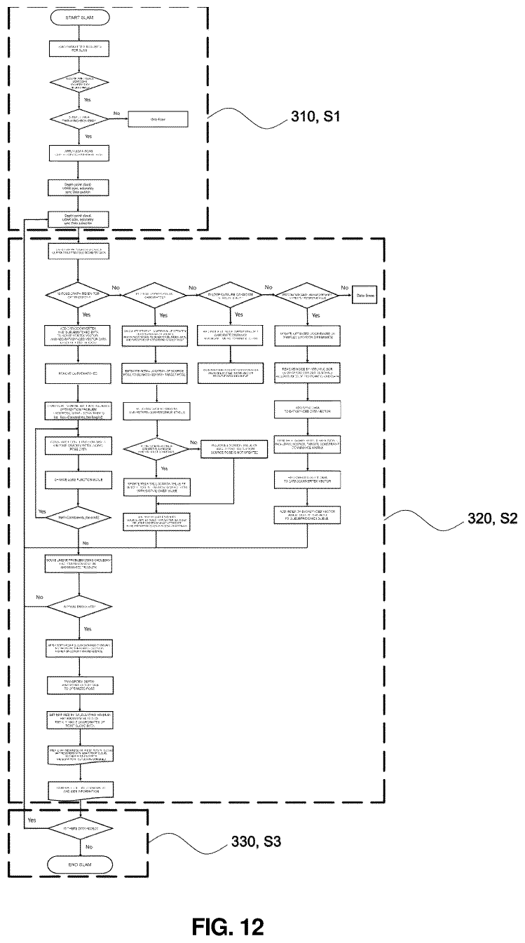

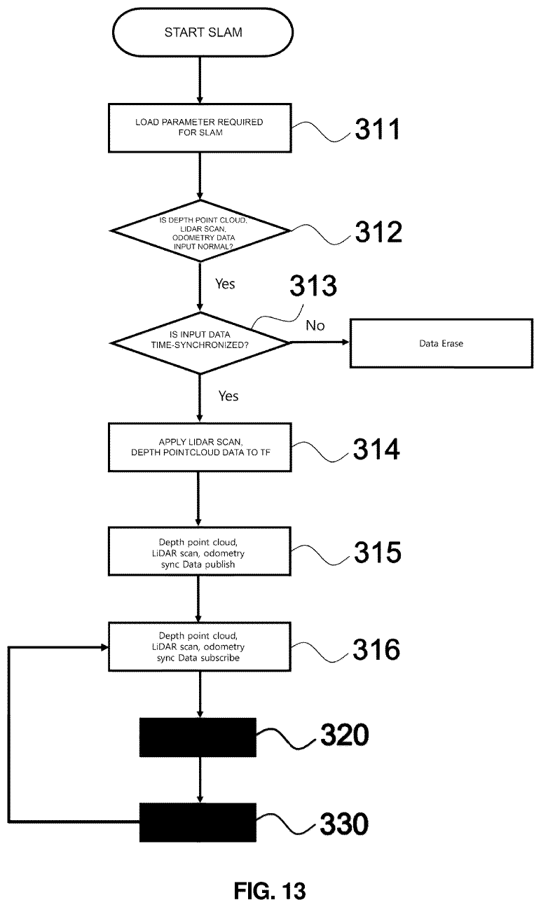

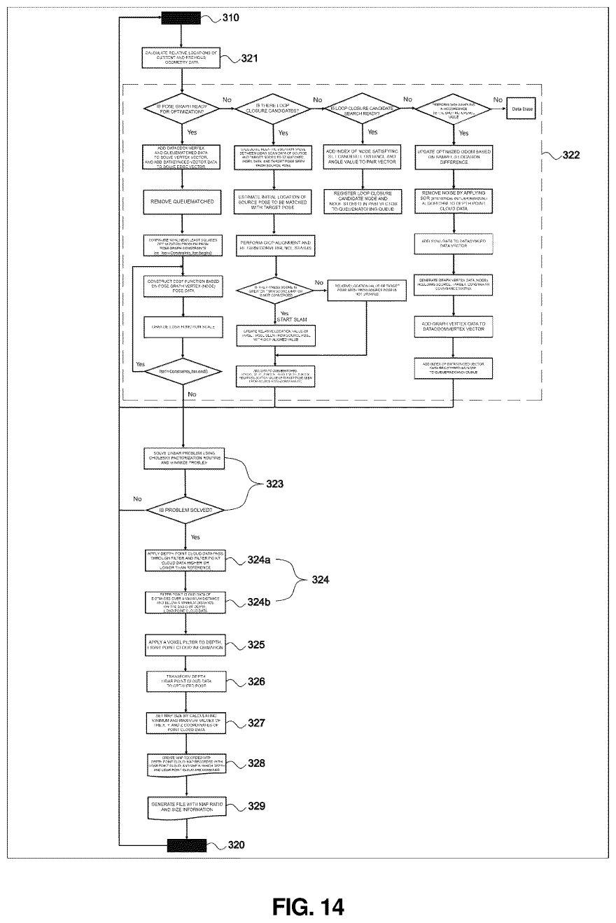

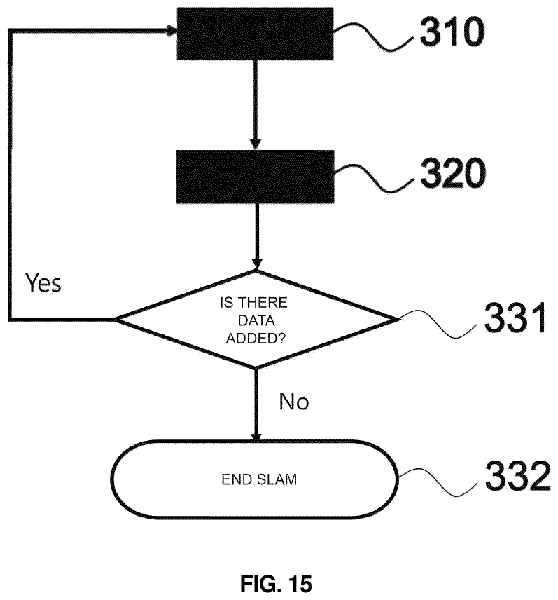

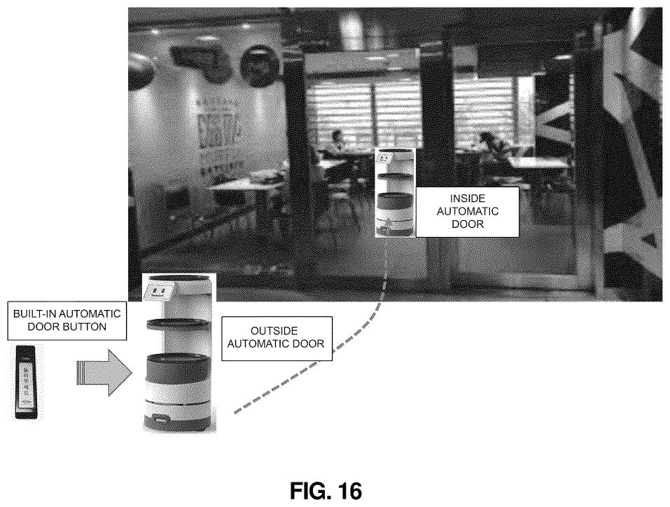

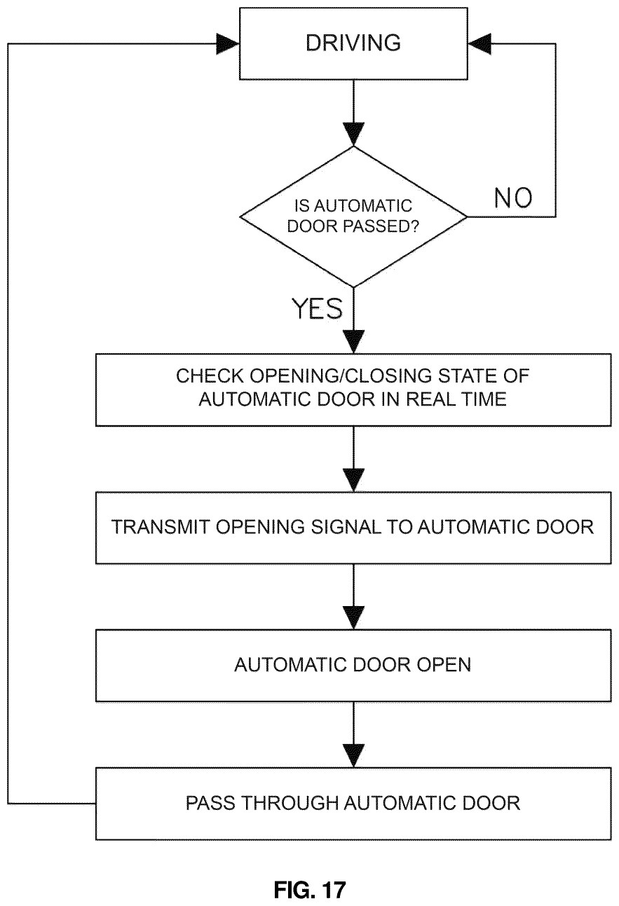

FIG. 1 is a conceptual diagram of an autonomous mobile service robot system for recognizing an automatic door of the present disclosure, FIG. 2 is a configuration diagram of the autonomous mobile service robot system for recognizing an automatic door of the present disclosure, FIG. 3 is a conceptual diagram of an autonomous mobile service robot of the components of the autonomous mobile service robot system for recognizing an automatic door of the present disclosure, FIG. 4 shows a first embodiment of the autonomous mobile service robot of the components of the autonomous mobile service robot system for recognizing an automatic door of the present disclosure, FIG. 5 shows a second embodiment of the autonomous mobile service robot of the components of the autonomous mobile service robot system for recognizing an automatic door of the present disclosure, FIGS. 6a and 6b are a conceptual diagram of a robot body system of the components of the autonomous mobile service robot system for recognizing an automatic door of the present disclosure, FIG. 7 is an operation flowchart of the autonomous mobile service robot of the components of the autonomous mobile service robot system for recognizing an automatic door of the present disclosure, FIG. 8 is a block diagram of a robot control unit of the components of the autonomous mobile service robot system for recognizing an automatic door of the present disclosure, FIG. 9 shows an embodiment of combining a robot body system and a robot function attachment/detachment module of the components of the autonomous mobile service robot system for recognizing an automatic door of the present disclosure, FIG. 10 shows another embodiment of the autonomous mobile service robot of the components of the autonomous mobile service robot system for recognizing an automatic door of the present disclosure, FIG. 11 shows a block diagram and a flowchart of a transparent object defining loop constructor of the components of the autonomous mobile service robot system for recognizing an automatic door of the present disclosure, FIG. 12 is an entire flowchart of the transparent object defining loop constructor of the components of the autonomous mobile service robot system for recognizing an automatic door of the present disclosure, FIG. 13 is a flowchart of a transparent object recognition SLAM building information preparation module of the transparent object defining loop constructor of the components of the autonomous mobile service robot system for recognizing an automatic door of the present disclosure, FIG. 14 is a flowchart of a transparent object recognition SLAM building settlement module of the transparent object defining loop constructor of the components of the autonomous mobile service robot system for recognizing an automatic door of the present disclosure, FIG. 15 is a flowchart of a transparent object recognition SLAM building completion module of the transparent object defining loop constructor of the components of the autonomous mobile service robot system for recognizing an automatic door of the present disclosure, FIG. 16 is a second conceptual diagram of the autonomous mobile service robot system for recognizing an automatic door of the present disclosure, and FIG. 17 briefly shows a flowchart when passing through an automatic door by the autonomous mobile service robot system for recognizing an automatic door of the present disclosure.

As shown in FIGS. 1 to 17, the present disclosure is characterized in that

an autonomous mobile service robot system (2) for recognizing an automatic door of the present disclosure includes:

an autonomous mobile service robot (1) providing service by moving and driving in a predetermined indoor space in accordance with specific paths and specific signal; and

an automatic door defining loop constructor (400) preventing errors in moving and driving of the autonomous mobile service robot (1) to be able to pass through an automatic door by recognizing and defining the automatic door in a predetermined indoor space when building a map of the autonomous mobile service robot (1) and by applying information about the recognized and defined automatic door to moving and driving of the autonomous mobile service robot 1,

wherein recognition and definition of the automatic door that are defined by the automatic door defining loop constructor (400) are processed on the basis of sensing information obtained from a surrounding environment information sensing unit (140) disposed in the autonomous mobile service robot (1), whereby the information about the automatic door is recognized and defined.

That is, the present disclosure relates to an autonomous mobile service robot system (2) for recognizing an automatic door, the autonomous mobile service robot system (2) enabling an autonomous mobile service robot (1) driving in a specific indoor space to recognize an automatic door by making it possible to build a map including location information of the automatic door through an automatic door defining loop constructor (400) when a specific indoor space map is built by the autonomous mobile service robot (1).

The autonomous mobile service robot (1) of the present disclosure is described in more detail with reference to FIGS. 1 to 20.

The autonomous mobile service robot (1), which is a serving robot as an embodiment, includes:

a robot body system (100) composed of a power source unit (110) that enables moving and driving in a predetermined indoor space in accordance with specific paths and specific signals, an additional function module mount unit (120) that enables robot functions to be added and mounted at any one or more of an upper portion and a lower portion, and a robot control unit (130) that controls the power source unit (110) in accordance with the robot functions mounted in the additional function module mount unit (120); and

a robot function attachment/detachment module (200) that is mounted on or separated from the additional function module mount unit (120) so that a manager can use the robot to correspond to situations by adding or changing functions in the robot,

in which the manager not only provides serving, but easily adds functions that can be used with serving to correspond to situations using the robot function attachment/detachment module (200), or converts the robot into specific robots having other functions, if necessary.

Accordingly, it is possible to maximize usability and utility of the serving robot.

That is, the autonomous mobile service robot (1) is based on a serving function that is a fundamental function of a serving robot, and independent modules having various inherent functions are detachably mounted on a side of the serving robot (the additional function module mount unit (120)) such that the inherent functions of the mounted independent modules, other than the serving function, are activated, whereby it is possible to perform complex functions.

In more detail, the robot body system (100), as described above, includes:

a serving robot housing (H) that is formed to be able to perform a serving function;

a power source unit (110) that is positioned and formed at the lower portion of the serving robot housing (H) and enables moving and driving in a predetermined indoor space in accordance with specific paths and specific signals;

an additional function module mount unit (120) that enables robot functions to be added and mounted at any one or more of an upper portion and a lower portion of the serving robot housing (H); and

a robot control unit (130) that controls the power source unit (110) in accordance with specific paths, specific signals, and the robot functions mounted on the additional function module mount unit (120),

in which a surrounding environment information sensing unit (140) that can obtain surrounding information in real time so that space information and path information can be created and updated is disposed on a side of the serving robot housing (H),

whereby all information about driving of the serving robot is obtained such that safe operating and driving are possible through the robot control unit (130).

In particular, 2D Lidar and an RGB-D sensor fusion technology are applied to the surrounding environment information sensing unit (140), for example, for precision in dynamic environment recognition of the serving robot.

Further, the additional function module mount unit (120) includes a module mount interface (121) that is formed such that the robot function attachment/detachment module (200) is detachably mounted on a side of the robot body system (100) and the robot control unit (130) can decode the inherent function of the mounted robot function attachment/detachment module (200), whereby the robot function attachment/detachment module (200) and the robot body system (100) are easily connected and separated.

Further, the robot control unit (130), as shown in FIG. 8, includes:

a serving mode activator (131) in which a serving mode (M1) coded with a serving function in advance is stored;

a module decoder (132) that decodes information input from the robot function attachment/detachment module (200); and

a power source controller (133) that controls the power source unit (110) on the basis of information that is transmitted from the serving mode activator (131) and the module decoder (132).

The module decoder (132) includes:

a module mounting checking element (132a) that checks whether the robot function attachment/detachment module (200) is mounted on the additional function module mount unit (120);

a module loading element (132b) that decodes coded programs of the robot function attachment/detachment module (200) mounted on the additional function module mount unit (120);

an additional function activation element (132c) that activates an inherent function mode (M2) of the robot function attachment/detachment module (200) decoded by the module loading element (132b); and

an additional function mode synchronization determination element (132d) that synchronizes the inherent function mode (M2) of the robot function attachment/detachment module (200) and the serving mode (M1) stored in the serving mode activator (131) such that the inherent function mode (M2) of the robot function attachment/detachment module (200) and the serving mode (M1) stored in the serving mode activator (131) are simultaneously activated, or the inherent function mode (M2) and the serving mode (M1) are alternately activated in accordance with predetermined time, or only the inherent function mode (M2) of the robot function attachment/detachment module (200) is activated.

Accordingly, it is possible to decode the programs coded in the robot function attachment/detachment module (200) and control the robot body system (100) to correspond to the inherent function mode (M2) of the robot function attachment/detachment module (200).

In this configuration, the additional function mode synchronization determination element (132d) has:

a serving mode (M1) for activating only a serving task;

a function mode (M2) for activating only a specific inherent function of the mounted robot function attachment/detachment module (200);

a complex mode (M1/2) for simultaneously activating the serving mode (M1) and the function mode (M2); and

a time delay mode (M1/2) for activating the serving mode (M1) and the function mode (M2) to correspond to a schedule set by a manager,

whereby variety of the functions of the serving robot is secured.

Further, the robot control unit (130) includes a driving space constructor (134) that creates a driving space of the serving robot that is operated and driven by the power source controller (133) so that the serving robot can autonomously drive in a specific space in accordance with specific signals.

The driving space constructor (134) includes:

a SLAM performing module (134a) that builds and creates of a map of real-time locations and a specific space on the basis of information obtained from the surrounding environment information sensing unit (140), an IMU, and an Odometry;

a built-map correcting module (134b) that corrects the map of a specific space built and created by the SLAM performing module (134a) to improve accuracy in driving and operating of the serving robot;

a built-map 2D converting module (134c) that converts 3D information about a surrounding environment created by the surrounding environment information sensing unit (140) into 2D information; and

a final driving space map building module (134d) that builds a driving space map of the serving robot by combining an RTAB-MAP result and the results by the SLAM performing module (134a), the built-map correcting module (134b), and the built-map 2D converting module (134c) into a single 2D map

whereby a driving space map of the serving robot is built as described above.

Further, a path setting unit (135) that creates and sets driving path of the serving robot on the basis of information constructed by the driving space constructor (134) is configured and includes:

a driving path performing module (135a) to which a probability circle-based space search (PCSS) algorithm, which performs path planning and path following for the shortest distance according to target coordinate input, is applied;

a driving path validity verifying module (135b) that verifies validity of IMU Dead reckoning and a driving location of the serving robot;

a local/global area return setting module (135c) that sets return through a local path and a global path by building a local cost-map for recognizing and avoiding obstacles by the surrounding environment information sensing unit (140) while the serving robot drives; and

a navigation difference calibrating module (135d) that performs navigation difference calibration of the serving robot,

whereby a global path and a local path, and navigation of the serving robot for the paths are achieved.

That is, a global path and a local path are required for the serving robot to move to a destination.

The global path is the entire path from a start point to a destination in the operating environment of the serving robot, and the local path is a partial path created to avoid obstacles using information detected while the serving robot drives.

The global path is available when information about all areas of a driving environment is provided, and the local path is required for the serving robot that serves close to people to secure safety for the people, assets, and environments.

Accordingly, the autonomous mobile service robot (1) of the present disclosure can detect and trace obstacles using an RGB-D sensor in a method of recognizing and avoiding obstacles to recognize the location of a first risk cause due to a contact with a person or other mobile components and sense in advance and manage a second risk cause of an autonomous driving error, and predict movement paths of obstacles after the current point in time by calculating movement tendency of the traced obstacles and applying a probability circle-based space search (PCSS) algorithm.

In this case, the predicted paths of obstacles are used to predict possibility of collision with the serving robot, and the movement paths of the obstacles make it possible to minimize meaningless driving of the robot and threats to walking people by creating a local path considering mobility of the obstacles and performing Kanayama control using a caution cost function through probability modeling.

Accordingly, it is possible to quickly and accurately detect and trace obstacles using only RGB-D sensor information.

Actual driving is performed in a path planning manner considering not only a driving path, but also mobility of obstacles by applying the probability circle-based space search (PCSS) algorithm rather than considering only the current locations of dynamic obstacles.

That is, it is possible to create a driving path that less threatens the walking people and is efficient to a destination while the serving robot drives through caution cost function comparison for obstacles, so the robot can safely drive even in a complicated environment with dynamic obstacles.

Further, the robot control unit (130) includes a robot driving controller (136) that controls driving of the serving robot by operating the power source controller (133) on the basis of information loaded, created, and set by the module decoder (132), the driving space constructor (134), and the path setting unit (135).

The robot driving controller (136) includes:

an actuator node control module (136a) that forms and controls a node for controlling the power source unit (110);

an open board module (136b) that controls or monitors the surrounding environment information sensing unit (140) and the power source unit (110);

a control platform porting module (136c) that sets a development tool arduino IDE of the open board module (136b) and ports a control platform ROS_Lib to the open board module (136b); and

a cooperation checking module (136d) that checks cooperation of the control platform porting module (136c) for stable operation of the robot driving controller (136),

whereby driving of the autonomous mobile service robot (1) can be controlled.

In this case, for example, an Arduino serial Multiple Servo OpenCR board may be applied as the open board module (136b).

Arduino may be a kind of micom boards that can perform inputting/outputting with a microprocessor.

Meanwhile, the robot function attachment/detachment module (200) that is mounted on and separated from the robot body system (100) and has various functions so that specific inherent functions of the serving robot other than a serving function can be activated, includes:

a module mounting/separating element (210) that can be mounted on and separated from the module mount interface (121) formed at the additional function module mount unit (120) of the robot body system (100);

an inherent function revealing element (220) that has a specific inherent function; and

an inherent function coding element (230) that is coded with a specific inherent function so that the inherent function revealing element (220) is activated by the robot control unit (130) when the module mounting/separating element (210) is mounted on the module mount interface (121).

Accordingly, various specific functions other than the serving function can be revealed, whereby the serving robot can perform complex functions.

The module mounting/separating element (210) is, as described above, is formed to be able to be easily mounted and separated in correspondence to the structure of the module mount interface (121) formed at the additional function module mount unit (120) of the robot body system (100).

The inherent function revealing element (220), for example, may include:

a crime prevention function module object (221) that includes an infrared CCTV camera and performs monitoring;

an advertisement function module object (222) that includes a 3D hologram projector and outputs promotion contents and performs promotion;

a carrying function module object (223) that includes a tray, which can carry loads and performs carrying;

a cleaning function module object (224) that includes a cleaner and performs cleaning;

a disinfection sanitization function module object (225) that includes a disinfection sanitization device and performs disinfection and sanitization; and

an air purification function module object (226) that includes an air purifier and purifies surrounding air.

Further, since various inherent function revealing elements (220) described above are formed, the inherent function coding element (230) is formed by coding an inherent specific function mode (M2) to correspond to the functions of the elements.

That is, other than the serving mode (M1) that is the fundamental function of the serving robot, an inherent function mode (M2) that enables complex functions simultaneously with the serving mode (M1), or inactivates the serving mode (M1) and can independently perform another function to correspond to situations is coded and mounted.

The function mode (M2) may be various modes in accordance with needs of the market such as a crime prevention mode, an advertisement mode, a carrying mode, a cleaning mode, a disinfection sanitization mode, and an air purification mode.

That is, as described above, the autonomous mobile service robot (1) has a structure that includes the robot function attachment/detachment module (200) that is an independent module being able to perform various functions and the robot body system (100) that recognizes information of the robot function attachment/detachment module (200) and synchronously operates so that independent modules that can easily apply another function mode (M2) other than the serving mode (M1) to a serving robot having the serving mode (M1) that is a fundamental function are easily mounted and separated to be able to perform complex functions when the robot function attachment/detachment module (200) is mounted and separated.

Accordingly, a manager can change a serving robot into a serving robot that can reveal other functions together with the serving task or can independently perform other functions after a serving task by easily adding functions other than the serving function to the serving robot, thereby enabling the serving robot to apply and use not only serving, but also functions other than serving.

For example, when the crime prevention function module object (221) is formed and the robot function attachment/detachment module (200) coded with the crime prevention mode (M2) is mounted on the robot body system (100), the robot can perform a serving task in hours for which a serving robot has to perform serving and monitor a specific space without a dead zone using an infrared CCTV camera in hours for which serving is not required.

When the advertisement function module object (222) is formed and the function attachment/detachment module (200) coded with the advertisement mode (M2) is mounted on the robot body system (100), the robot can output, advertise, and promote promotion contents (a cooking video, a completed food video, etc.) using a 3D hologram projector while performing serving.

The most important characteristic of the autonomous mobile service robot (1) of the present disclosure described above is independent modularization of the robot function attachment/detachment module (200).

This is for making it possible to quickly cope with needs and changes of the market by developing and designing only the robot function attachment/detachment module (200) having necessary functions when new complex functions are required other than the fundamental function of a serving robot in domestic and foreign markets.

FIG. 7 is a brief operation flowchart of the autonomous mobile service robot of the components of the autonomous mobile service robot system for recognizing a transparent object of the present disclosure.

In detail, the flowchart is composed of:

an independent module docking step (S100) in which the robot function attachment/detachment module (200) is mounted on the robot body system (100);

an independent module docking checking step (S200) that checks whether the robot function attachment/detachment module (200) has been correctly mounted on the robot body system (100) through the independent module docking step (S100) such that the inherent function mode (M2) thereof is performed;

an independent module function mode loading step (S300) that loads information of the inherent function mode (M2) from the robot function attachment/detachment module (200) of which correct mounting has been checked through the independent module docking checking step (S200);

a serving robot complex function performing checking step (S400) that checks whether the serving mode (M1) fundamentally mounted in the robot body system (100) and the inherent function mode (M2) loaded from the independent module function mode loading step (S300) are activated;

a serving robot complex function activation step (S500) that activates the serving mode (M1) and the function mode (M2) simultaneously or at different times through the serving robot complex function performing checking step (S400); and

a manager calling-out step (S600) that calls out a manager to be able to correctly mount again the robot function attachment/detachment module (200) when the robot function attachment/detachment module (200) has been unstably mounted in the independent module docking checking step (S200).

Further, in the autonomous mobile service robot (1) of the present disclosure, the robot body system (100) further includes an emotional speech outputting unit (P) that enables conversation with customers while serving ordered food to customers at tables in consideration of emotion of customers in accordance with additional situations.

For example, information can be received from location based service of a weather station and simple greetings can be expressed to customers using a display and a speaker in accordance with the weather of each day.

Further, consequently, as shown in FIG. 10, the autonomous mobile service robot (1) of the present disclosure constructs a serving robot docking station system (S) that is scheduled by a manager to mount and separate by itself the robot function attachment/detachment module (200) having a specific inherent function mode (M2) and activates the serving mode (M1) and the function mode (M2) to be able to perform the functions thereof in accordance with the schedule so that the manager can control the functions and the operation according to a schedule of the autonomous mobile service robot (1) by only making and setting a schedule and transmitting the made and set scheduling information to the serving robot docking station system (S) or the robot body system (100).

For reference, a robot operation system (ROS) software platform is applied to the robot control unit (130) included in the autonomous mobile service robot (1) of the present disclosure.

An ROS is a meta operating unit that provides libraries for a development environment and various developing and debugging tools such as abstracting hardware for robot application programs, controlling, sensing, and recognizing a device, building a map, providing a motion planning function, passing a process message, and managing packages.

Further, an ROS is convenient to use for development in a PC because it is operated over an OS such as Ubuntu.

Representative single board computers (SBC) such as Raspberry Pi, ODROID, Intel Edison, BeagleBone, and TX2 for driving an ROS are actually used in robots.

Further, a serving robot for reducing the development cost uses 8bit MCUs such as AVR, so there are many difficulties in configuration of hardware and development of programs for robot motions and accuracy is also considerably decreased in location recognition and driving of a robot.

Accordingly, the autonomous mobile service robot (1) of the present disclosure uses Nvidia Jetson TX2 (8 GB) SBC for hardware configuration and is equipped with Ubuntu 16.04, ROS Melodic as an OS such that hardware and software platforms that is the safest and can secure reliability in development of serving robot application programs and a driving technology is configured.

Further, the power source unit (110) included in the autonomous mobile service robot (1) of the present disclosure means an assembly of mechanical elements that should be physically operated for the autonomous mobile service robot (1) to move and perform specific tasks (the serving mode (M1), the function mode (M2), the complex mode (M12), and the time delay mode (M1/2) such as a wheel, a shaft, a motor, and a robot arm.

Further, the term “specific path” in the specification means driving space information and driving path information that are created by the robot control unit (130), more specifically, the driving space constructor (134) and the path setting unit (135).

The term “specific signal” means a control signal that is transmitted and input from the robot control unit (130), more specifically, the power source controller (133) and the robot driving controller (136).

FIG. 9 shows an embodiment of combining the robot body system (100) and the robot function attachment/detachment module (200) of the components of the autonomous mobile service (1) of the present disclosure, that is, an embodiment of the combination structure for mounting and separating them in a sliding type.

In short, the autonomous mobile service robot (1) of the present disclosure is composed of a robot body system (100) composed of a power source unit (110) that enables moving and driving in a predetermined indoor space in accordance with specific paths and specific signals, an additional function module mount unit (120) that enables robot functions to be added and mounted at any one or more of an upper portion and a lower portion, and a robot control unit (130) that controls the power source unit (110) in accordance with the robot functions mounted in the additional function module mount unit (120); and

A robot function attachment/detachment module (200) that is mounted on or separated from the additional function module mount unit (120) of the robot body system (100) so that a manager can use the robot to correspond to situations by adding or changing functions in the robot,

in which the manager not only provides serving, but also easily adds functions that can be used with serving to correspond to situations using the robot function attachment/detachment module (200), or converts the robot into specific robots having other functions, if necessary, thereby maximizing usability and utility of a serving robot.

The robot body system (100) includes:

a serving robot housing (H) that is formed to be able to perform a serving function;

the power source unit (110) that is positioned and formed at the lower portion of the serving robot housing (H) and enables moving and driving in a predetermined indoor space in accordance with specific paths and specific signals;

the additional function module mount unit (120) that enables robot functions to be added and mounted at any one or more of an upper portion and a lower portion of the serving robot housing (H); and

the robot control unit (130) that controls the power source unit (110) in accordance with specific paths, specific signals, and the robot functions mounted on the additional function module mount unit (120),

in which a surrounding environment information sensing unit (140) that can obtain surrounding information in real time so that space information and path information can be created and updated is disposed on a side of the serving robot housing (H),

whereby all information about driving of the serving robot is obtained such that safe operating and driving are possible through the robot control unit (130).

2D Lidar and an RGB-D sensor fusion technology are applied to the surrounding environment information sensing unit (140) for precision in dynamic environment recognition of the serving robot.

The additional function module mount unit (120) includes a module mount interface (121) that is formed such that the robot function attachment/detachment module (200) is detachably mounted on a side of the robot body system (100) and the robot control unit (130) can decode the inherent function of the mounted robot function attachment/detachment module (200), whereby the robot function attachment/detachment module (200) and the robot body system (100) are easily connected and separated.

The robot control unit (130) includes:

a serving mode activator (131) in which a serving mode (M1) coded with a serving function in advance is stored;

a module decoder (132) that decodes information input from the robot function attachment/detachment module (200); and

a power source controller (133) that controls the power source unit (110) on the basis of information that is transmitted from the serving mode activator (131) and the module decoder (132).

The module decoder (132) includes:

a module mounting checking element (132a) that checks whether the robot function attachment/detachment module (200) is mounted on the additional function module mount unit (120);

a module loading element (132b) that decodes coded programs of the robot function attachment/detachment module (200) mounted on the additional function module mount unit (120);

an additional function activation element (132c) that activates an inherent function mode (M2) of the robot function attachment/detachment module (200) decoded by the module loading element (132b); and

an additional function mode synchronization determination element (132d) that synchronizes the inherent function mode (M2) of the robot function attachment/detachment module (200) and the serving mode (M1) stored in the serving mode activator (131) such that the inherent function mode (M2) of the robot function attachment/detachment module (200) and the serving mode (M1) stored in the serving mode activator (131) are simultaneously activated, or the inherent function mode (M2) and the serving mode (M1) are alternately activated in accordance with predetermined time, or only the inherent function mode (M2) of the robot function attachment/detachment module (200) is activated.

Accordingly, it is possible to decode the programs coded in the robot function attachment/detachment module (200) and control the robot body system (100) to correspond to the inherent function mode (M2) of the robot function attachment/detachment module (200).

The additional function mode synchronization determination element (132d) has:

a serving mode (M1) for activating only a serving task;

a function mode (M2) for activating only a specific inherent function of the mounted robot function attachment/detachment module (200);

a complex mode (M12) for simultaneously activating the serving mode (M1) and the function mode (M2); and

a time delay mode (M1/2) for activating the serving mode (M1) and the function mode (M2) to correspond to a schedule set by a manager,

whereby variety of the functions of the serving robot is secured.

The robot control unit (130) includes a driving space constructor (134) that creates a driving space of the serving robot that is operated and driven by the power source controller (133) so that the serving robot can autonomously drive in a specific space in accordance with specific signals.

The driving space constructor (134) includes:

a SLAM performing module (134a) that builds and creates of a map of real-time locations and a specific space on the basis of information obtained from the surrounding environment information sensing unit (140), an IMU, and an Odometry;

a built-map correcting module (134b) that corrects the map of a specific space built and created by the SLAM performing module (134a) to improve accuracy in driving and operating of the serving robot;

a built-map 2D converting module (134c) that converts 3D information about a surrounding environment created by the surrounding environment information sensing unit (140) into 2D information; and

a final driving space map building module (134d) that builds a driving space map of the serving robot by combining the results by the SLAM performing module (134a), the built-map correcting module (134b), and the built-map 2D converting module (134c) into a single 3D map, whereby a driving space map of the serving robot is built.

Further, a path setting unit (135) that creates and sets driving path of the serving robot on the basis of information constructed by the driving space constructor (134) is configured and includes:

a driving path performing module (135a) to which an algorithm, which performs path planning and path following for the shortest distance according to target coordinate input, is applied;

a driving path validity verifying module (135b) that verifies validity of IMU Dead reckoning and a driving location of the serving robot;

a local/global area return setting module (135c) that sets return through a local path and a global path by building a local cost-map for recognizing and avoiding obstacles by the surrounding environment information sensing unit (140) while the serving robot drives; and

a navigation difference calibrating module (135d) that performs navigation difference calibration of the serving robot,

whereby a global path and a local path, and navigation of the serving robot for the paths are achieved.

The embodiment of the autonomous mobile service robot (1) described above relates to a multi-functional module type serving robot.

A transparent object defining loop constructor (300) that distinguishes, recognizes, and defines a transparent object and an opaque object, which is an objective of the present disclosure, can be applied to a common serving robot composed of only the robot body system (100) as well as a service robot that can be applied to various places in addition to a multi-functional module type serving robot that is an embodiment.

Meanwhile, the transparent object defining loop constructor (300) that enables the autonomous mobile service robot (1) to drive while distinguishing transparent objects and opaque objects by defining information about transparent objects and opaque objects existing in a specific indoor space to be applied to the driving space constructor (134) when a map of a specific indoor space is built by the driving space constructor (134) is described in more detail with reference to FIGS. 11 to 15. The transparent object defining loop constructor (300) is characterized by including:

a transparent object recognition SLAM building information preparation module (310) that collects information for building a map;

a transparent object recognition SLAM building settlement module (320) that recognizes and defines opaque objects and transparent objects by space analyzing and mapping on the basis of point cloud information obtained from the opaque objects; and

a transparent object recognition SLAM building completion module (330) that checks and examines whether there is new information for space analyzing and mapping

so that transparent objects and opaque objects are distinguished and defined and a complete map for a specific indoor space to which the objects are applied is built when a map is built by the autonomous mobile service robot (1).

As described above, the transparent object defining loop constructor (300) includes:

a transparent object recognition SLAM building information preparation module (310) that collects information for building a map;

a transparent object recognition SLAM building settlement module (320) that recognizes and defines opaque objects and transparent objects by space analyzing and mapping on the basis of point cloud information obtained from the opaque objects; and

a transparent object recognition SLAM building completion module (330) that checks and examines whether there is new information for space analyzing and mapping.

The transparent object recognition SLAM building information preparation module (310) includes:

a SLAM parameter loading element (311) that takes parameters required for building a map from information about the specific indoor space obtained by the autonomous mobile service robot (1);

a SLAM parameter checking element (312) that checks and examines the validity (normal data) of point cloud information of a 3D space loaded and input from the SLAM parameter loading element (311), lidar scan information, and traveling distance information;

a SLAM parameter information time synchronization checking element (313) that checks whether the items of information that are checked and examined by the SLAM parameter checking element (312) are time-synchronized;

an autonomous mobile service robot transform applying element (314) that applies the current location, direction, and movement of the autonomous mobile service robot (1) to the lidar scan information and the point cloud information of a 3D space when the SLAM parameter information time synchronization checking element (313) determines that time synchronization has been made;

an autonomous mobile service robot driving environment information publishing element (315) that publishes the point cloud information of a 3D space, the lidar scan information, and the traveling distance information to which the current location of the autonomous mobile service robot (1) has been applied, which are applied by the autonomous mobile service robot transform applying element (314); and

an autonomous mobile service robot driving environment information subscribing element (316) that subscribes the point cloud information of a 3D space, the lidar scan information, and the driving distance information to which the current location of the autonomous mobile service robot (1) has been applied, which are published on the autonomous mobile service robot driving environment information publishing element (315), and

prepares for building a map of a specific indoor space on the basis of various items of information obtained from the autonomous mobile service robot (1).

The transparent object recognition SLAM building settlement module (320) includes:

a driving distance information calculation element (321) that calculates relative locations of current and previous driving distance information;

a loop combination noise removal SLAM optimization element (322) that performs and registers optimization of self location and direction information of the autonomous mobile service robot (1) and loop closure on the basis of information prepared by the transparent object recognition SLAM building information preparation module (310);

a cholesky factorization-using problem solving element (323) that solves 1D linear problems and minimizes problems using cholesky factorization;

a SLAM transparent object recognition settlement element (324) that filters point cloud information created by point cloud information of a 3D space and lidar scan information under specific conditions so that a map is built;

a point cloud voxel filter applying element (325) that applies a voxel filter to 3D space and lidar point cloud information settled by the SLAM transparent object recognition settlement element (324);

a SLAM optimization information applying element (326) that applies the 3D space and lidar point cloud information to the current location, direction, and movement of the optimized autonomous mobile service robot (1);

a space SLAM size setting element (327) that sets a map size by calculating minimum and maximum values in an x, y, and z coordinates of the 3D space and lidar point cloud information;

an indoor space SLAM creating element (328) that creates a map recorded with 3D space point cloud information, a map recorded with lidar point cloud information, and a map of a specific indoor space combined with 3D space and lidar point cloud information; and

a SLAM ratio size information creating element (329) that creates a file including ratio and size information in the maps created by the indoor space SLAM creating element (328).

The SLAM transparent object recognition settlement element (324) includes:

a 3D space SLAM transparent object recognition settlement filter (324a) that filters point cloud information higher and lower than a first specific reference value SD1 recognized and defined as a transparent object by applying information about a transparent object recognized and defined by the loop combination noise removal SLAM optimization element (322) to point cloud information of a 3D space; and

a transparent opaque object point cloud distinguish settlement filter (324b) that filters point cloud information of distances over a maximum distance and below a minimum distance from a second specific reference value SD2 on the basis of point cloud information created by 3D space and lidar scan information

so that a map of a specific indoor space to which transparent object and opaque object information have been applied is built.

The transparent object recognition SLAM building completion module (330) includes:

a SLAM building additional information checking element (331) that checks whether there is information that is additionally obtained in relation to driving of the autonomous mobile service robot (1); and

an autonomous mobile service robot SLAM work finishing element (332) that finishes SLAM work when there is no additional information related to driving of the autonomous mobile service robot (1) that has been checked by the SLAM building additional information checking element (331)

so that building a map of a specific indoor space to which transparent object and opaque object information has been applied is finished.

(b) of FIG. 11 briefly shows a flowchart for the transparent object defining loop constructor (300), which includes:

a transparent object recognition SLAM building information preparation step (S1) that prepares for building a map of a specific indoor space through the transparent object recognition SLAM building information preparation module (310);

a transparent object recognition SLAM building settlement step (S2) that builds a map through the transparent object recognition SLAM building settlement module (320) on the basis of information about the specific indoor space prepared in the transparent object recognition SLAM building information preparation step (S1); and

a transparent object recognition SLAM building completion step (S3) that checks whether there is information added to build a map through the transparent object recognition SLAM building completion module (330) before a map of the specific indoor space is built and completed, and completes a map after the transparent object recognition SLAM building settlement step (S2),

whereby a map of a specific indoor space including information about transparent objects and opaque objects is built in the autonomous mobile service robot (1) through the transparent object defining loop constructor (300).

Meanwhile, an automatic door defining loop constructor (400) enables the autonomous mobile service robot (1) to recognize automatic doors and drive (smoothly pass through the automatic doors) by defining location information about automatic doors existing in a specific indoor space such that the location information is applied to the driving space constructor (134) when a map of the specific indoor space is built by the autonomous mobile service robot 1.

The automatic door defining loop constructor (400) is characterized by including:

a repeat learning automatic door location automatic selection module (410) that senses and selects a location candidate group of automatic doors when a map of a predetermined indoor space is initially built by the autonomous mobile service robot (1), and determines the locations of the automatic doors by comparing a map that is built by repeated driving in the predetermined indoor space with the initially built map such that the locations of the automatic doors are updated in a map; and

a manager automatic door location manual selection module (420) that senses and selects a location candidate group of automatic doors when a map of a predetermined indoor space is initially built by the autonomous mobile service robot (1), and determines the locations (coordinates) of the automatic doors in the built map such that the locations of the automatic doors are updated in the map by a manager

so that the autonomous mobile service robot (1) can recognize the locations of the automatic doors, pass through the automatic doors while driving, and then provide service.

In this case, a location candidate group of automatic doors is sensed and selected through the automatic door defining loop constructor (400), for example, such that locations at which the autonomous mobile service robot (1) cannot move forward, and is interfered while moving, senses shock, or tries to avoid obstacles while driving and locations at which an error is generated in driving of the autonomous mobile service robot (1) are sensed and selected as the location candidate group of automatic doors.

Further, the automatic door defining loop constructor (400) further includes an automatic location checking unit (430) that senses whether driving is possible and checks determination of locations of automatic doors using an automatic opening signal creating/transmitting unit (500) at the locations of the location candidate group of automatic doors sensed and selected by the autonomous mobile service robot (1) when the locations of automatic doors are determined through the repeat learning automatic door location automatic selection module (410) so that automatic door location information is determined and applied to a built map.

That is, an opening signal is transmitted to automatic doors through the automatic opening signal creating/transmitting unit (500) at locations of the selected location candidate group of automatic doors so that the state of the automatic doors (whether the automatic doors are opened in response to the signal from the automatic opening signal creating/transmitting unit (500)) can be sensed and the locations of the automatic doors can be determined.

Further, the autonomous mobile service robot system (2) for recognizing an automatic door of the present disclosure further includes the automatic opening signal creating/transmitting unit (500) that enables the autonomous mobile service robot (1) to pass through automatic doors safely without interference by the automatic doors and to provide service to customers by transmitting an opening signal to the automatic doors when the autonomous mobile service robot (1) needs to pass through the automatic doors while driving along an optimal path so that the autonomous mobile service robot (1) passes through the automatic doors and smoothly provides service.

In this case, the autonomous mobile service robot (1) transmits an automatic signal through the automatic opening signal creating/transmitting unit (500) in advance before passing through the automatic doors so that the automatic doors open.

That is, the automatic opening signal creating/transmitting unit (500) includes:

a real-time automatic door opening/closing information reception module (510) that receives open/close state information of automatic doors in real time; and

an automatic door opening signal transmission module (520) that transmits an opening signal to automatic door when the autonomous mobile service robot (1) is a predetermined distance away from the automatic doors if location information of the automatic doors is included in an optimal path along which the autonomous mobile service robot (1) drives,

whereby, as described above, the autonomous mobile service robot (1) can smoothly pass through automatic doors.

For reference, a serving robot that autonomously drives in indoor diners, food courts, and restaurants was just exemplified as an embodiment of the autonomous mobile service robot (1) in the present disclosure.

The autonomous mobile service robot (1) means a robot that autonomously drives in a predetermined indoor space and provide service corresponding to situations in accordance with various situations, purposes, and roles, and

for example, as described above, may be a robot that can provide various types of service in a predetermined indoor space such as a diner, a food court, a restaurant, a department store, a museum, a gallery, a government and municipal office, and a public institution.

That is, the present disclosure pursues safer and more complete autonomous driving of the autonomous mobile service robot (1) by building a map in which location information of automatic doors is defined when the autonomous mobile service robot (1) builds a map through the automatic door defining loop constructor (400).

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### Industrial Applicability

The present invention relates to an autonomous mobile service robot system for recognizing an automatic door and can contribute to the promotion of the overall optimization industry of the service robots related to robot hardware and software and program execution developed and manufactured for the main purpose of service, in particular, the development of hardware for autonomous mobile service robots to perform various functions.

1. An autonomous mobile service robot system (2) for recognizing an automatic door, comprising:
an autonomous mobile service robot (1) providing service by moving and driving in a predetermined indoor space in accordance with specific paths and specific signal; and
an automatic door definition loop constructor (400) preventing errors in moving and driving of the autonomous mobile service robot (1) to be able to pass through an automatic door in the predetermined indoor space by recognizing and defining the automatic door existing in the predetermined indoor space when building a map of the autonomous mobile service robot (1) and by applying information about the defined automatic door to moving and driving of the autonomous mobile service robot (1),
wherein recognition and definition of the automatic door that are determined by the automatic door defining loop constructor (400) are processed on the basis of sensing information obtained from a surrounding environment information sensing unit (140) disposed in the autonomous mobile service robot (1), whereby the information about the automatic door is recognized and defined.

2. The autonomous mobile service robot system for recognizing an automatic door of claim 1, wherein
the automatic door defining loop constructor (400) includes:
a repeat learning automatic door location automatic selection module (410) that senses and selects a location candidate group of automatic doors when a map of a predetermined indoor space is initially built by the autonomous mobile service robot (1), and determines the locations of the automatic doors by comparing a map that is built by repeated driving in the predetermined indoor space with the initially built map such that the locations of the automatic doors are updated in a map; and
a manager automatic door location manual selection module (420) that senses and selects a location candidate group of automatic doors when a map of a predetermined indoor space is initially built by the autonomous mobile service robot (1), and determines the locations (coordinates) of the automatic doors in the built map such that the locations of the automatic doors are updated in the map by a manager,
whereby the autonomous mobile service robot (1) can recognize the locations of the automatic doors, pass through the automatic doors while driving, and then provide service.

3. The autonomous mobile service robot system for recognizing an automatic door of claim 2,
wherein the location candidate group of automatic doors is sensed and selected through the automatic door defining loop constructor (400) such that locations at which the autonomous mobile service robot (1) cannot move forward, and is interfered while moving, senses shock, or tries to avoid obstacles while driving and locations at which an error is generated in driving of the autonomous mobile service robot (1) are sensed and selected as the location candidate group of automatic doors when a map of a predetermined indoor space is built by the autonomous mobile service robot (1).
